(19) United States
(12) Patent Application Publication
(10) Pub. No.: US 2025/0076075 A1
(43) Pub. Date: Mar. 6, 2025

(54) ENHANCEMENTS TO MAP OVER THE AIR UPDATE

(71) Applicant: QUALCOMM Incorporated, San Diego, CA (US)

(72) Inventors: Vinod Kumar ENAPAKURTHI, Vizianagaram (IN); Ravi Kumar SEPURI, Hyderabad (IN)

(21) Appl. No.: 18/461,419

(22) Filed: Sep. 5, 2023

(51) Int. Cl. G01C 21/00

(52) U.S. Cl. CPC G01C 21/3819

(57) ABSTRACT

Aspects presented herein may enable a UE (e.g., a vehicle, an on-board unit (OBU) of the vehicle, an advanced driver assistance systems (ADAS) of the vehicle, a device running a navigation application, etc.) to download map data in packets based on a set of priorities to improve the efficiency of updating/retrieving map data. In one aspect, a UE calculates a route to a destination based on a current location of the UE and map data. The UE receives, from a server, an indication of updated map data associated with the calculated route, where the updated map data includes a plurality of packets. The UE sets a priority for a download of one or more packets of the plurality of packets based on a set of live parameters. The UE downloads the one or more packets of the updated map data based on the set priority.

### TECHNICAL FIELD

The present disclosure relates generally to communication systems, and more particularly, to a wireless communication involving map data updating.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus calculates a route to a destination based on a current location of a user equipment (UE) and map data. The apparatus receives, from a server, an indication of updated map data associated with the calculated route, where the updated map data includes a plurality of packets. The apparatus sets a priority for a download of one or more packets of the plurality of packets based on a set of live parameters. The apparatus downloads the one or more packets of the updated map data based on the set priority.

In an aspect of the disclosure, a method, a computer-readable medium, and an apparatus are provided. The apparatus transmits, to a user equipment (UE), a first indication of map data. The apparatus receives, from the UE, a second indication of a calculated route for the UE and a set of live parameters. The apparatus configures updated map data associated with the calculated route and the set of live parameters, where the updated map data includes a plurality of packets. The apparatus transmits, to the UE, a third indication of the updated map data associated with the calculated route and the set of live parameters.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of camera-aided positioning in accordance with various aspects of the present disclosure.

FIG. 6 is a diagram illustrating an example of a navigation application in accordance with various aspects of the present disclosure.

FIG. 7 is a diagram illustrating an example of a vehicle performing map over the air in accordance with various aspects of the present disclosure.

FIG. 8 is a diagram illustrating an example of transmitting map data over the air in multiple packets based on a set of priorities in accordance with various aspects of the present disclosure.

FIG. 9 is a diagram illustrating an example of transmitting map data over the air in multiple packets based on a set of priorities in accordance with various aspects of the present disclosure.

FIG. 10 is a flowchart illustrating an example algorithm for determining the priority for map updating in accordance with various aspects of the present disclosure.

FIG. 11 is a flowchart of a method of wireless communication.

FIG. 12 is a diagram illustrating an example of a hardware implementation for an example apparatus and/or network entity.

FIG. 13 is a flowchart of a method of wireless communication.

FIG. 14 is a diagram illustrating an example of a hardware implementation for an example network entity.

### DETAILED DESCRIPTION

Aspects presented herein may improve the efficiency of a map over the air (MOTA) process, thereby improving the performance, latency, an/or accuracy of applications specifying map data, such as applications for autonomous driving, navigation, and positioning, etc. Aspects presented herein may enable map data updates, such as for high-definition (HD) maps, to be transmitted to a device based on a priority, such that map over the air process is optimized by dividing the details of the map data into priority-based chunks. Aspects presented herein may also improve the speed/latency of map data updates based on crowd sourcing (e.g., which may be beneficial for fully autonomous vehicles). In one aspect of the present disclosure, an algorithm for a system is provided to enable the system to determine the priority of downloading different map data packets dynamically based on location(s) and current/estimate route(s) of a vehicle. For example, a system that is running on a vehicle (e.g., an on-board unit (OBU) of the vehicle, an advanced driver assistance systems (ADAS) of the vehicle, etc.) may be configured to dynamically notify or negotiate with a server (e.g., a cloud server, a map server, etc.) to segregate map data based on a set of priorities, and the system may update the map data packets based on a priority flag.

Aspects presented herein are directed to enhancements of OTA (over-the-air) map updates to provide more optimal OTA map updates based on the needs of individual vehicles. Map updates are prioritized based on current location and route of the vehicle. The present disclosure includes the following aspects: customizable updates per profile/vehicle; determine and decide the priority dynamically based on current location and current route of the vehicle. System that is running the vehicle will dynamically notify or negotiate with could server to segregate map data updates based on set priorities and update the packets with priority flag; map can be updated in chunks based on priority and vehicle will receive priority data immediately. Detailed Process: 1. Device determines vehicle route path and direction based on GPS location and Route map path. 2. Device periodically checks with the server to see if there are any available updates, in the route path that it is travelling. 3. Assuming HD map data from server is categorized based on priority and segregated over multiple OTA packets. 4. Based on vehicle speed, location and direction, system can determine the priority. 5. Device checks for the high priority flag and downloads the package on priority while other updates are downloaded in the background. 6. The device will verify the integrity of the update package to ensure that it is authentic and has not been tampered with during the download process.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

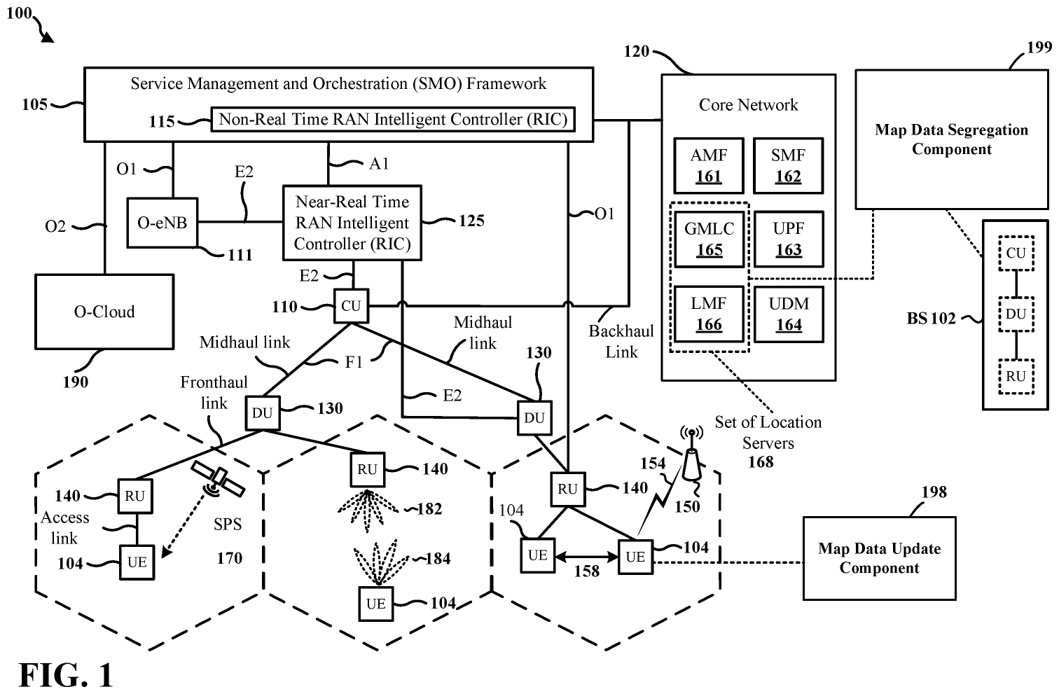

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a map data update component 198 that may be configured to calculate a route to a destination based on a current location of the UE and map data; receive, from a server, an indication of updated map data associated with the calculated route, where the updated map data includes a plurality of packets; set a priority for a download of one or more packets of the plurality of packets based on a set of live parameters; and download the one or more packets of the updated map data based on the set priority. In certain aspects, the base station 102 or the one or more location servers 168 may have a map data segregation component 199 that may be configured to transmit, to a UE, a first indication of map data; receive, from the UE, a second indication of a calculated route for the UE and a set of live parameters; configure updated map data associated with the calculated route and the set of live parameters, where the updated map data includes a plurality of packets; and transmit, to the UE, a third indication of the updated map data associated with the calculated route and the set of live parameters.

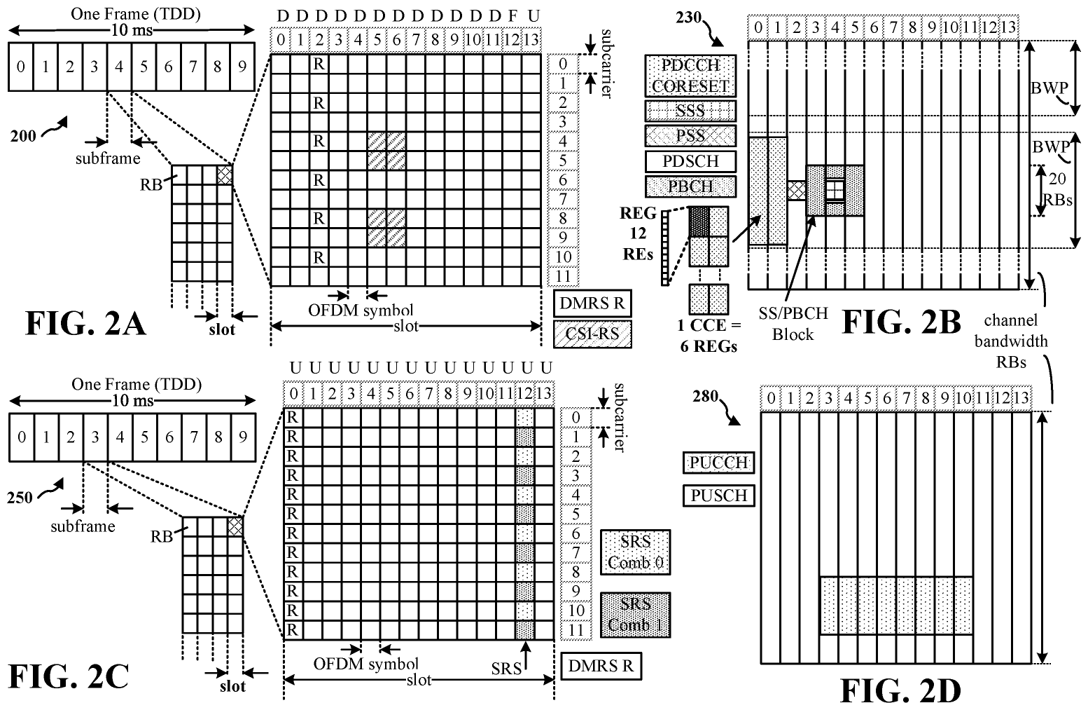

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

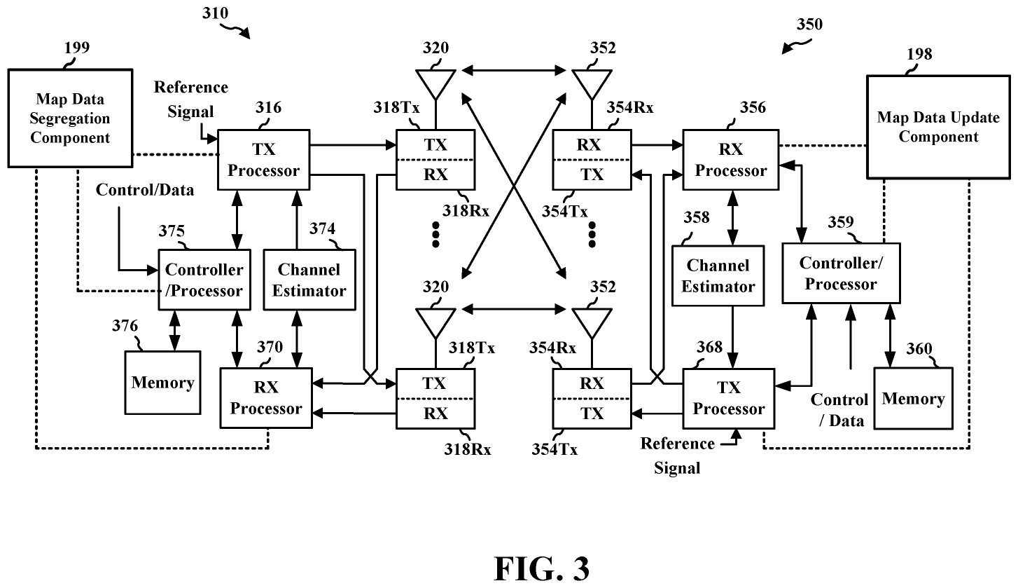

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the map data update component 198 of FIG. 1.

At least one of the TX processor 316, the RX processor 370, and the controller/processor 375 may be configured to perform aspects in connection with the map data segregation component 199 of FIG. 1.

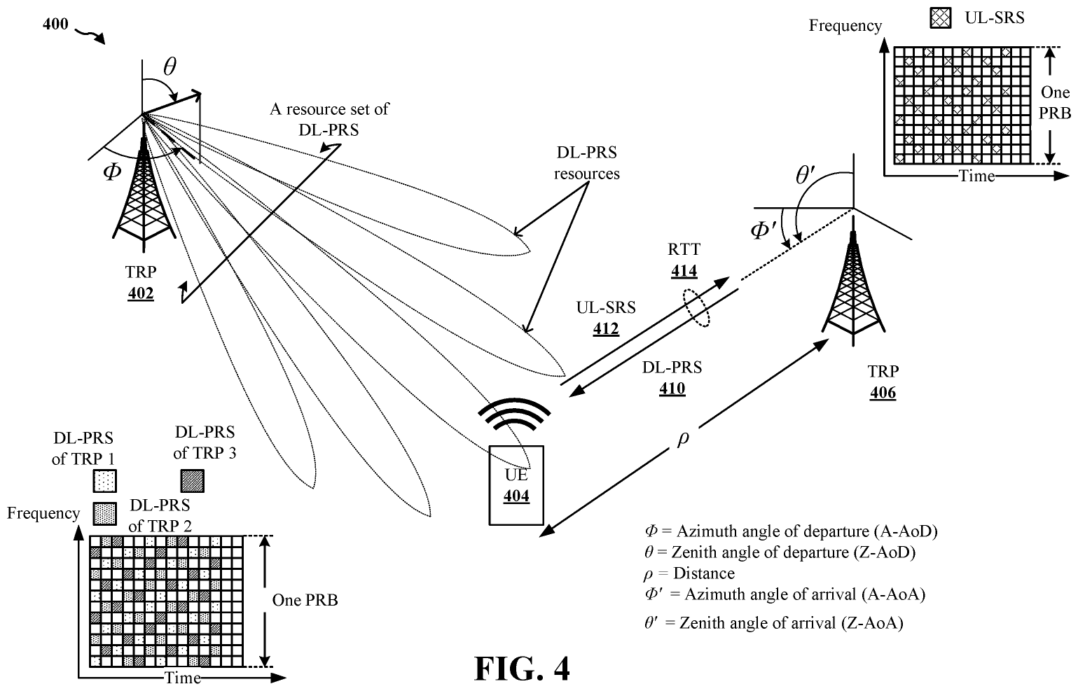

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_Rx}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on μT_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to Global Navigation Satellite Systems (GNSS)-based positioning and network-based positioning (e.g., as described in connection with FIG. 4), various camera-based positioning has also been developed to provide alternative/additional positioning mechanisms/modes. Camera-based positioning, which may also be referred to as “camera-based visual positioning,” “visual positioning” and/or “vision-based positioning,” is a positioning mechanism/mode that uses images captured by at least one camera to determine the location of a target (e.g., a UE or a transportation that is equipped with the at least one camera, an object that is in view of the at least one camera, etc.). For example, images captured by the dashboard camera (dash cam) of a vehicle may be used for calculating the three-dimensional (3D) position and/or 3D orientation of the vehicle while the vehicle is moving. Similarly, images captured by the camera of a mobile device may be used for estimating the location of the mobile device user or the location of one or more objects in the images. In another example, a camera (or a UE) may determine its position by matching object(s) in images captured by the camera with object(s) in a map (e.g., a high-definition (HD) map), such as specified buildings, landmarks, etc. In some implementations, camera-based positioning may provide centimeter-level and 6-degrees-of-freedom (6DOF) positioning. 6DOF may refer to a representation of how an object moves through 3D space by either translating linearly or rotating axially (e.g., 6DOF=3D position+3D attitude). For example, a single-degree-of-freedom on an object may be controlled by the up/down, forward/back, left/right, pitch, roll, or yaw. Camera-based positioning has great potential for various applications, especially in satellite signal (e.g., GNSS/GPS signal) degenerated/unavailable environments.

In some scenarios, images captured by a camera may also be used for improving the accuracy/reliability of other positioning mechanisms/modes (e.g., the GNSS-based positioning, the network-based positioning, etc.), which may be referred to as “vision-aided positioning,” “camera-aided positioning,” “camera-aided location,” and/or “camera-aided perception,” etc. For example, while GNSS and/or inertial measurement unit (IMU) may provide good positioning/localization performance, when GNSS measurement outage occurs, the overall positioning performance might degrade due to IMU bias drifting. Thus, images captured by the camera may provide valuable information to reduce errors. For purposes of the present disclosure, a positioning session (e.g., a period of time in which one or more entities are configured to determine the position of a UE) that is associated with camera-based positioning or camera-aided positioning may be referred to as a camera-based positioning session or a camera-aided positioning session. In some examples, the camera-based positioning and/or the camera-aided positioning may be associated with an absolute position of the UE, a relative position of the UE, an orientation of the UE, or a combination thereof.

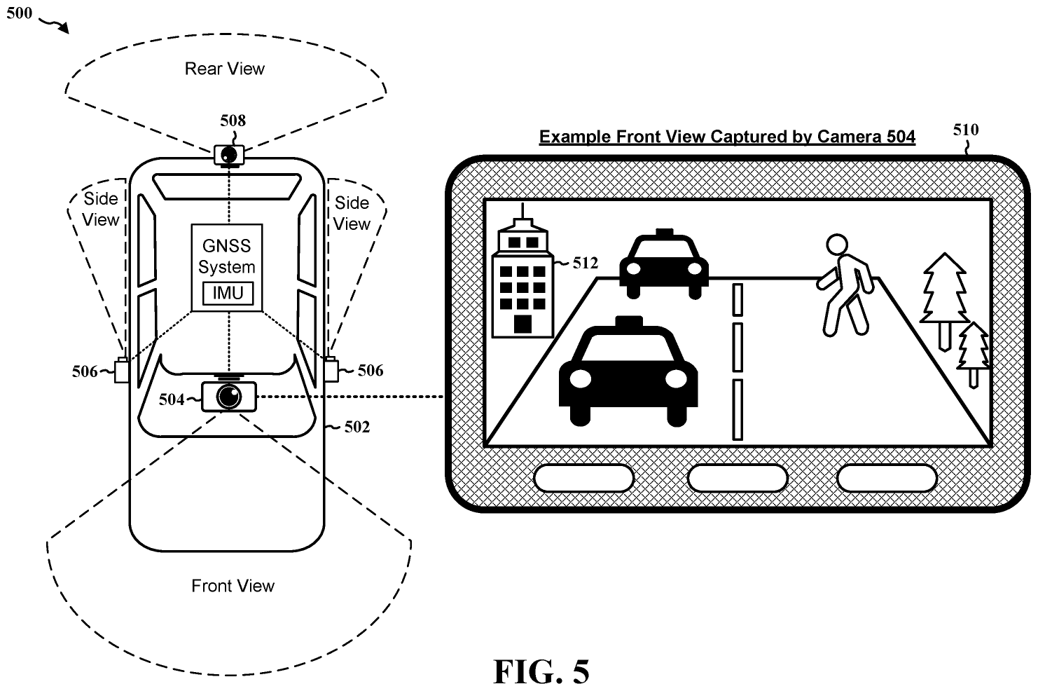

FIG. 5 is a diagram 500 illustrating an example of camera-aided positioning in accordance with various aspects of the present disclosure. A vehicle 502 may be equipped with a GNSS system and a set of cameras, which may include a front camera 504 (for capturing the front view of the vehicle 502), side cameras 506 (for capturing the side views of the vehicle 502), and/or a rear camera 508 (for capturing the front view of the vehicle 502), etc. In some examples, the GNSS system may further include or be associated with at least one IMU (e.g., a GNSS+IMU system). While FIG. 5 uses the vehicle 502 as an example, it is merely for illustration purposes. Aspects presented herein may also apply to other types of transportations (e.g., motorcycles, bicycles, buses, trains, etc.), devices (e.g., UEs on pedestrians), and/or positioning mechanisms/modes (e.g., network-based positioning described in connection with FIG. 4). In addition, for purposes of the present disclosure, a positioning mechanism/mode (e.g., GNSS-based positioning, network-based positioning, etc.) that uses at least one sensor (e.g., an IMU, a camera) to assist the positioning may be referred to as a sensor fusion positioning.

The GNSS system may estimate the location of the vehicle 502 based on receiving GNSS signals transmitted from multiple satellites (e.g., based on performing GNSS-based positioning). However, when the GNSS signals are not available or weak, such as when the vehicle 502 is in an urban area or in a tunnel, the estimated location of the vehicle 502 may become inaccurate. Thus, in some implementations, the set of cameras on the vehicle 502 may be used for assisting the positioning, such as for verifying whether the location estimated by the GNSS system based on the GNSS signals is accurate. For example, as shown at 510, images captured by the front camera 504 of the vehicle 502 may include/identify a specific building 512 (which may also be referred to as a feature) that is with a known location, and the vehicle 502 (or the GNSS system or a positioning engine associated with the vehicle 502) may determine/verify whether the location (e.g., the longitude and latitude coordinates) estimated by the GNSS system is in proximity to the known location of this specific building 512. Thus, with the assistance of the camera(s), the accuracy and reliability of the GNSS-based positioning may be further improved. For purposes of the present disclosure, a GNSS system that is associated with a camera (e.g., capable of performing camera-aided/based positioning) may be referred to as a “GNSS+camera system,” or a “GNSS+IMU+camera system” (if the GNSS system is also associated with/includes at least one IMU).

In some examples, a software or an application that accepts positioning related measurements from GNSS chipsets and/or sensors to estimate position, velocity, and/or altitude of a device may be referred to as a positioning engine. In addition, a positioning engine that is capable of achieving certain high level of accuracy (e.g., centimeter/decimeter level accuracy) and/or latency may be referred to as a precise positioning engine (PPE). For example, a positioning engine that is capable of performing real-time kinematic positioning (RTK) (e.g., receiving or processing correction data associated with RTK) may be considered as a PPE. Another example of PPE is a positioning engine that is capable of performing precise point positioning (PPP). PPP is a positioning technique that removes or models GNSS system errors to provide a high level of position accuracy from a single receiver.

In some examples, a software or an application that accepts positioning related measurements from global navigation satellite system (GNSS)/global positioning system (GPS) chipsets and/or sensors to estimate position, velocity, and/or altitude of a device may be referred to as a positioning engine (PE). In addition, a positioning engine that is capable of achieving certain high level of accuracy (e.g., centimeter/decimeter level accuracy) and/or latency may be referred to as a precise positioning engine (PPE). On the other hand, a navigation application may refer to an application in a user equipment (e.g., a smartphone, an in-vehicle navigation system, a GPS device, etc.) that is capable of providing navigational directions in real time. Over the last few years, users have increasingly relied on navigation applications because they have provided various benefits. For example, navigation applications may provide convenience to users as they enable users to find a way to their destinations, and also allow users to contribute information and mark places of importance thereby generating the most accurate description of a location. In some examples, navigation applications are also capable of providing expert guidance for users, where a navigation application may guide a user to a destination via the best, most direct, or most time-saving routes. For example, a navigation application may obtain the current status of traffic, and then locate a shortest and fastest way for a user to reach a destination, and also provide approximately how long it will take the user to reach the destination. As such, a navigation application may use an Internet connection and a GPS/GNSS navigation system to provide turn-by-turn guided instructions on how to arrive at a given destination.

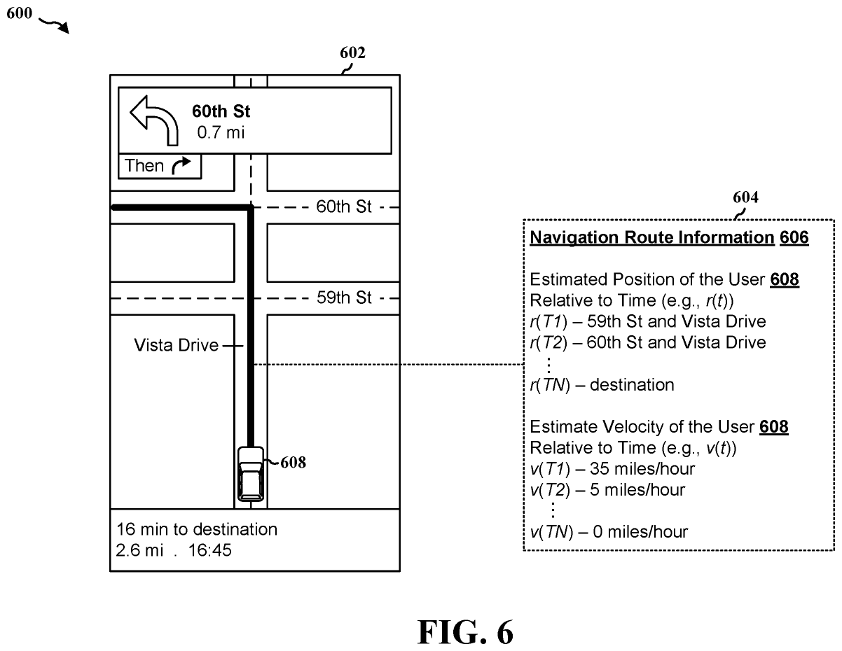

FIG. 6 is a diagram 600 illustrating an example of a navigation application in accordance with various aspects of the present disclosure. As shown at 602, a navigation application, which may be running on a UE such as a vehicle (e.g., a built-in GPS/GNSS system of the vehicle) or a smartphone, may provide a user (e.g., via a display or an interface) with turn-by-turn directions to a destination and an estimated time to reach the destination based on real-time information. For example, the navigation application may receive/download real-time traffic information, road condition information, local traffic rules (e.g., speed limits), and/or map information/data from a server. Then, the navigation application may calculate a route to the destination based on at least the map information and other available information. The map information may include the map of the area in which the user is traveling, such as the streets, buildings, and/or terrains of the area, or a map that is compatible with the navigation application and GPS/GNSS system. In some examples, the route calculated by the navigation application may be the shortest or the fastest route. For purposes of the present disclosure, information associated with this calculated route may be referred to as navigation route information. For example, navigation route information may include predicted/estimated positions, velocities, accelerations, directions, and/or altitudes of the user at different points in time.

For example, as shown at 604, based on the map information, the speed limit, and the real-time road condition information, the navigation application may generate navigation route information 606 that guides a user 608 to a destination. In some examples, the navigation route information 606 may include the position of the user and velocity of the user relative/respect to time, which may be denoted as \vec{r}(t) and \vec{v}(t), respectively. For example, the navigation application may estimate that at a first point in time (T1), the user may reach a first point/place with certain speed (e.g., the intersection of 59th Street and Vista Drive with a velocity of 35 miles per hour), and at a second point in time (T2), the user may reach a second point/place with certain speed (e.g., the intersection of 60th Street and Vista Drive with a velocity of 15 miles per hour), and up to N^{th} point in time (TN), etc.

In recent years, vehicle manufacturers have been developing vehicles with autonomous driving capabilities. Autonomous driving, which may also be called as self-driving or driverless technology, may refer to the ability of a vehicle to navigate and operate itself without specifying human intervention (e.g., without a human controlling the vehicle). The goal of the autonomous driving is to create vehicles that are capable of perceiving their surroundings, making decisions, and controlling their movements, all without the direct involvement of a human driver.

To achieve or improve the autonomous driving, a vehicle may be specified to use a map (or map data) with detailed information, such as a high-definition (HD) map. An HD map may refer to a highly detailed and accurate digital map designed for use in autonomous driving and advanced driver assistance systems (ADAS). In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc. As HD maps are capable of providing detailed and up-to-date information about the road network, including lane-level data, traffic signs, road markings, and other important features, etc., HD maps may be an important aspect for enabling autonomous vehicles to navigate complex environments and make informed decisions in real-time.

As described in connection with FIGS. 5 and 6, various applications (e.g., use cases) such as camera-aided positioning, navigation, and/or autonomous driving, etc., may specify the use of map data. To keep the map data up-to-date, these applications (or devices running these applications) may be configured to download updated map data from a server from time to time or based on certain pre-defined conditions (e.g., when travelling to an area that is without map data). In some implementations, downloading map data from a server may be referred to as “map over the air” (MOTA).

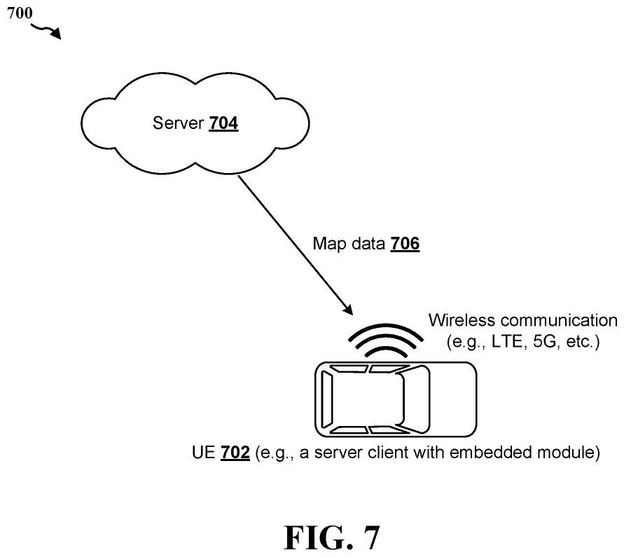

FIG. 7 is a diagram 700 illustrating an example of a vehicle performing map over the air in accordance with various aspects of the present disclosure. In one example, map over the air may refer to a process of a server 704 sending real-time map data 706 to a UE 702 (e.g., a vehicle, an on-board unit (OBU) of the vehicle, an ADAS of the vehicle, a device running a navigation application, etc.) over a wireless network (e.g., an LTE network, a 5G network, etc.), enabling the UE 702 to make decisions based on the latest information about the road and traffic conditions, such as described in connection with FIGS. 5 and 6. In a typical implementation, the map data 706 is transmitted from the server 704 (e.g., a cloud-based system), where the server 704 may utilize sensors and other data sources to collect and analyze information about the road network and traffic patterns. This data is then processed and combined with other data, such as GPS/GNSS and camera data from multiple users (e.g., from other UEs/vehicles and/or the UE 702) to create a detailed map of the environment in real-time. Then, an application (e.g., for autonomous driving, navigation, positioning, etc.) of the UE 702 may access the map data 706 over a wireless network (e.g., a cellular or satellite network), and use the map data 706 to make decisions about speed, route, and other factors, etc. For example, the UE 702 may use the map data 706 to avoid road construction, traffic congestion, or accidents, and to optimize its route for efficiency and safety, etc.

In some scenarios, map data, such as HD map data, may be specified to be highly detailed and thus may be large in sizes, which may pose challenges in terms of bandwidth and latency when transmitting the map data over a wireless network. This may cause delays in the delivery of important/specified map data to UEs. For example, if an autonomous driving vehicle does not have sufficient/reliable network bandwidth to download the real-time map data, it may impact the autonomous driving vehicle's ability to operate safely and efficiently. As typical map over the air update process may take a considerable amount of time, a seamless integration of map data (e.g., map data) with other sensors, such as Lidar, radar, and cameras, etc. to provide a comprehensive view of the environment around the vehicle may be beneficial and specified.

As per typical/current map over the air process, a device (e.g., a UE, a vehicle, etc.) may be configured to look for map data updates periodically, download the delta map data (e.g., referring to differences between the current map data on a server and the map data in the device), and the device may update its map data based on the downloaded delta map data. Usually, these map data updates are clubbed/combined and made as a common downloadable package for multiple/all devices (e.g., for crowd sourcing users). For example, one current approach for updating the map data is based on an “one to many” mechanism, where a single package may be made and shared with multiple/all users (e.g., vehicles) as the update. However, based on the trends and technology (e.g., such as for crowd sourcing, autonomous driving, positioning, and navigation), each user may have different priorities for map data updates based on their location and/or frequently used routes. Thus, having customizable updates per profile/user/vehicle is likely a more optimized approach.

Aspects presented herein may improve the efficiency of map over the air process, thereby improving the performance, latency, an/or accuracy of applications specifying map data, such as applications for autonomous driving, navigation, and positioning, etc. Aspects presented herein may enable map data updates, such as for HD maps, to be transmitted to a device based on a priority, such that the map over the air process is optimized by dividing the details of the map data into priority-based chunks. Aspects presented herein may also improve the speed/latency of crowd sourcing updates (e.g., which may be beneficial for fully autonomous vehicles). In one aspect of the present disclosure, an algorithm for a system is provided to enable the system to determine and decide the priority dynamically based on location(s) and current route(s) (e.g., of a vehicle). For example, the system that is running a vehicle (e.g., an on-board unit (OBU) of the vehicle, an advanced driver assistance systems (ADAS) of the vehicle, etc.) may be configured to dynamically notify or negotiate with a server (e.g., a cloud server, a map server, etc.) to segregate map data based on a set of priorities, and the system may update the map packets based on a priority flag.

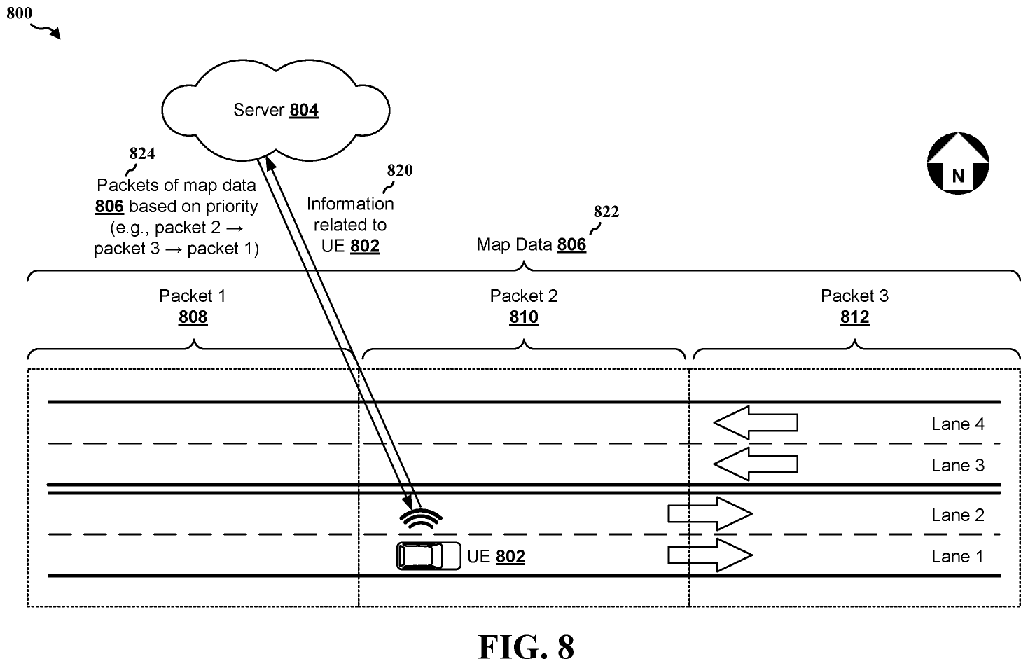

FIG. 8 is a diagram 800 illustrating an example of transmitting map data over the air in multiple packets based on a set of priorities in accordance with various aspects of the present disclosure. In one example, map data 806 (which may also be a map data update or delta map data) that covers an area may be large in size (e.g., 900 megabytes (MBs)). Instead of downloading the whole map data 806 at the same time (e.g., at once or in one download), a server 804 (e.g., a map server, a cloud server, etc.) may be configured to categorize/segregate the map data 806 based on at least one input from a UE 802 (e.g., a vehicle, an OBU of the vehicle, an ADAS of the vehicle, a device running a navigation application, etc.).

In one example, the at least one input may include information related to the UE 802, such as the location of the UE 802, the destination of the UE 802, the speed of the UE 802, the direction of the UE 802, frequency route(s) used by the UE 802, and/or the planned/current route path (e.g., computed by a navigation application) of the UE 802, etc. Thus, this information may include a set of live parameters related to the UE 802. For purposes of the present disclosure, a live parameter may refer to a most updated parameter or a parameter that is currently happening. For example, a live parameter of a UE may be a current location/speed/direction of the UE, etc. In some examples, the UE 802 may determine its current or estimated location based on GNSS/GPS, or using network-based positioning as described in connection with FIG. 4. The UE 802 may also determine its destination (and also the planned route/path to the destination) based on an input from the user of the UE 802 (e.g., the UE 802 is a navigation device/system or running a navigation application, etc.) and an existing map data in the UE 802. In other examples, the server 804 may determine the current location/estimated location of the UE 802, the destination of the UE 802, and/or the route of the UE 802 based on information provided by the UE 802 (or information from other sources) and the map data associated with area(s) travelled by and/or expected to be travelled by the UE 802.

In some configurations, based on the information related to the UE 802, the UE 802 may be configured to periodically check with the server 804 to see if there are any available map data updates, such as for the routes/paths that the UE 802 is travelling. If there are map data updates, the server 804 may transmit an indication of the map data updates to the UE 802. For example, the UE 802 may be travelling towards an eastern direction on a first lane (Lane 1) of a highway (using a frequently used route or a route planned by a navigation application) at a certain speed towards City A (e.g., a destination input by the user), and the UE 802 may check with the server 804 on whether there are any updates for map data (e.g., may include real-time traffic information, road conditions, etc.) between the current location of the UE 802 and City A. If there are map data updates between the current location of the UE 802 and City A, the server 804 may transmit an indication of such updates to the UE 802.

As shown at 820, the UE 802 may provide information related to the UE 802 to the server 804 (or the server 804 may detect such information using sensors or received them from another entity). Based on this information, the server 804 may segregate/divide the map data 806 into multiple packets (which may also be referred to as over-the-air (OTA) packets or map data packets) and assign a priority for each packet. In some examples, the server 804 may be configured to segregate the map data 806 into multiple packets first (e.g., based on file sizes, area sizes, zones, etc.), and then assign the priorities to the packets based on information related to the UE 802. In other examples, the server 804 may be configured to determine the information related to the UE 802 first (e.g., received from the UE 802 or detected using sensors, etc.), and segregate the map data 806 into multiple packets with assigned priorities based on information related to the UE 802 (e.g., the map data is segregated by the server based on the specification of each UE where each map data packet may not have a fixed area size or file size). In other examples, the priorities may be set by the UE 802 based on similar or the same priority rules applied at the server 804 (e.g., the algorithm of determining/setting the priorities for packets are implemented at the UE 802).

For example, as shown at 822, the server 804 (or the UE 802) may segregate the map data 806 into three packets, where a first packet 808 may cover an area that is opposite to the direction travelled by the UE 802, a second packet 810 may cover an area that is current travelled by the UE 802, and a third packet 812 may cover an area that is estimated/predicted to be travelled by the UE 802 after certain periods or distances. The first packet 808, the second packet 810, and the third packet 812 may have the same size (e.g., 300 MBs) or different sizes (e.g., the second packet 810 has 100 MBs, the third packet 812 has 200 MBs, and the third packet 812 has 600 MBs, etc.) depending on the implementation.

Based on information related to the UE 802 (e.g., the speed, location, and/or direction of the UE 802, etc.), the server 804 (or the UE 802) may assign or associate each packet with a priority. For example, the second packet 810 may be assigned with a highest priority as it covers the area that is currently travelled by the UE 802, the third packet 812 may be given a lesser priority compared to the second packet 810 as it covers the area which is likely to be travelled by the UE 802, and the first packet 808 may be given a lowest priority compared to the first packet 808 and the second packet 810 as it is unlikely to be travelled by the UE 802.

Then, as shown at 824, the server 804 may transmit the packets of the map data 806 (or the UE 802 may download the packets of the map data 806) based on the priorities associated with the packets. For example, the server 804 may transmit (or the UE 802 may download) the second packet 810 first, then the third packet 812, and then the first packet 808, etc. As such, the UE 802 may be able to update the map data in chunks based on the priority, where the UE 802 may be able to receive priority data immediately. In some examples, map data packet(s) with high priorities may be indicated by a high priority flag, and the UE 802 may be configured to check the server 804 for the high priority flag and download these packets on priority while other packets/updates may be downloaded based on a lesser priority or on a background (e.g., downloading the lesser priority map data packets when the UE 802 has spared resources/bandwidths or does not impact the downloading of the high priority map data).

In another example, as the UE 802 is currently travelling on the first lane (Lane 1), the server 804 (or the UE 802) may segregate the map data 806 based on lane(s). For example, map data packet(s) related to the first lane (Lane 1) and a second lane (Lane 2) may be given a higher priority compared to map data packet(s) related to a third lane (Lane 3) and a fourth lane (Lane 4) as the first lane (Lane 1) and the second lane (Lane 2) have the same moving direction as the UE 802. In another example, the server 804 (or the UE 802) may segregate the map data 806 based on locations. For example, map data packet(s) related to the designation of the UE 802 (e.g., inputted by the user of the UE 802, such as for navigation purposes) may be given a higher priority compared to map data packets for areas unrelated to the designation of the UE 802 (e.g., areas beyond the designation, areas already travelled, etc.).

In some implementations, after the UE 802 downloads a map data packet, the UE 802 may be configured to verify the integrity of the map data packet to ensure that it is authentic and has not been tampered with or corrupted during the download process. In one example, if the UE 802 verifies a map data packet to be non-authentic or tampered/corrupted, the UE 802 may discard that map data packet and/or request the server 804 to resend that map data packet (e.g., the UE 802 may redownload that map data packet).

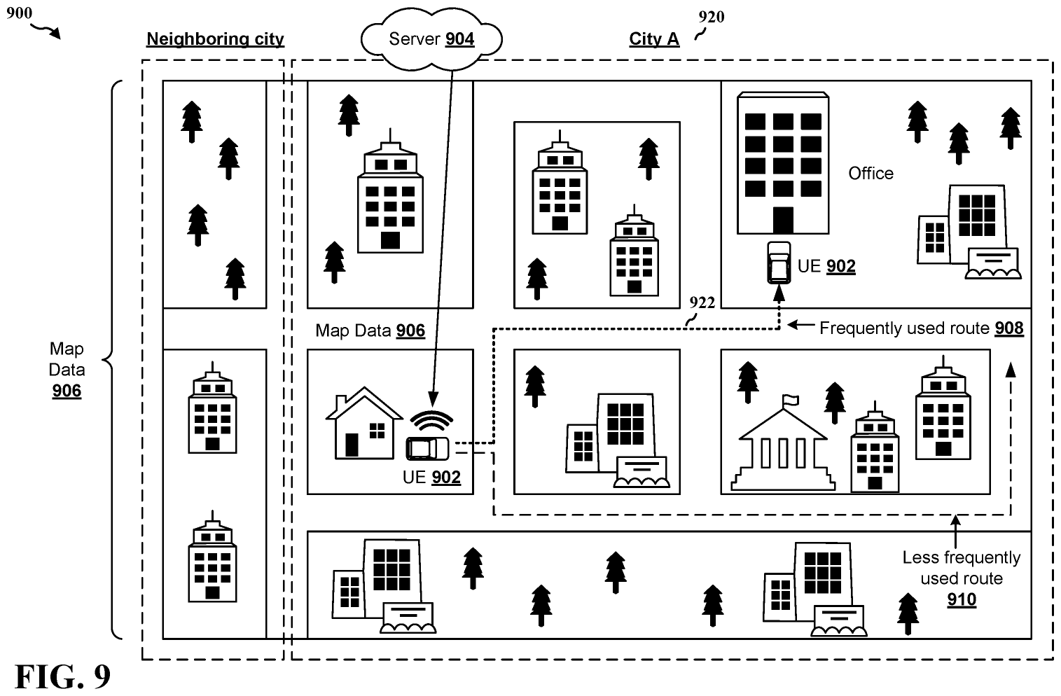

FIG. 9 is a diagram 900 illustrating an example of transmitting map data over the air in multiple packets based on a set of priorities in accordance with various aspects of the present disclosure. In another example, as shown at 920, a map (e.g., a HD map) of City A may have some updates at a server 904 (e.g., a map server, a cloud server, etc.) or the entire map of City A may be recently added to the server. Thus, a UE 902 (e.g., a vehicle, an OBU of the vehicle, an ADAS of the vehicle, a device running a navigation application, etc.) may be specified to download/update its local map database (e.g., referring to an existing map data that is currently stored at one or more memories of the UE 902) for City A.

Instead of downloading and updating the whole map data 906 for City A at the same time (e.g., at once or in one download), as shown at 922, when a user starts the UE 902 and moves in a direction of frequently used route 908, the UE 902 may identify that the frequently used route 908 is being used and request the server 904 to update map data or map data packet(s) related to the frequently used route 908 and/or map data or map data packet(s) towards the destination (e.g., the office of the user) as high priority, and the server 904 and/or the UE 902 may update remaining map data or map data packet(s) with less priority compared to the frequently used route. For examples, the UE 902 may be configured to download the map data or map data packet(s) related to a less frequently used route 910 or the map data or map data packet(s) of a neighboring city in the background (e.g., downloading the map data when the UE 902 has spared resources/bandwidths or does not impact the downloading of the high priority map data). In some examples, the UE 902 may determine/identify the frequently used route 908 based on previous trips (e.g., the user has taken the same route for X times during Y trips). As such, aspects presented herein may improve the map data update more efficiently for the UE 902 by enabling the UE 902 to update frequency used routes (e.g., to the user's office, home, often-visited places, etc.) as high priority as it is in the user's frequently used route list.

In some implementations, based on the current location and/or the planned/estimated route path of the UE 902, the UE 902 may dynamically update the map data packet downloading priority. For example, if the UE 902 detects that the user is using the less frequently used route 910, the UE 902 may prioritize downloading of (or requesting the server 904 to prioritize transmitting of) the map data related to the less frequently used route 910. In another example, if the UE 902 detects that the user starts to move towards the neighboring city which also has a map data update, the UE 902 may dynamically switches the priority and gets the map data update towards the moving path of the UE 902 (e.g., for the neighboring city).

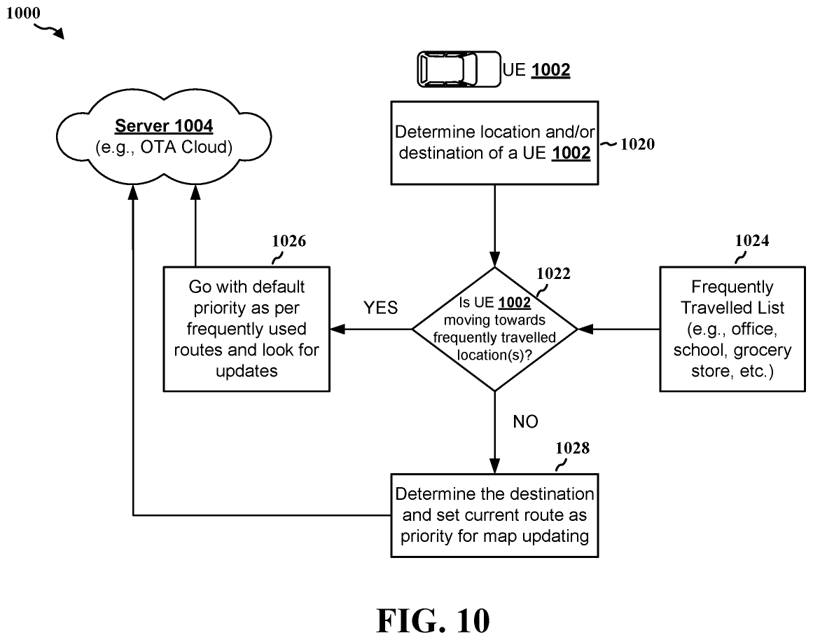

FIG. 10 is a flowchart 1000 illustrating an example algorithm for determining the priority for map updating in accordance with various aspects of the present disclosure. In one example, as shown at 1020, a UE 1002 (e.g., a vehicle, an OBU of the vehicle, an ADAS of the vehicle, a device running a navigation application, etc.) may be configured to determine its location and/or its destination. For example, the UE 1002 may determine its current or estimated location based on GNSS/GPS, or using network-based positioning as described in connection with FIG. 4. The UE 1002 may also determine its destination (and also a planned route/path to the destination) based on an input from the user of the UE 1002 (e.g., the UE 1002 is a navigation device/system or running a navigation application, etc.).

As shown at 1022, based on the location and/or the destination (and the planned route/path to the destination) of the UE 1002, and also based on a list of frequently travelled routes/places by the UE 1002 as shown at 1024 (which may be obtained/computed by the UE 1002 from previous trips), the UE 1002 may determine whether it is moving towards a place/destination or using a set of routes that is in the list of frequently travelled routes/places.

As shown at 1026, if the UE 1002 determines that it is moving towards a place/destination or using a set of routes that is in the list of frequently travelled routes/places, the UE 1002 may apply a default priority for downloading map data packets from a server 1004. For example, map data packet(s) related to the list of frequently travelled routes/places may be given a highest priority, whereas other map data packet(s) (e.g., map data packet(s) not in the list) may be given a lower priority (compared to the map data packets in the list).

On the other hand, as shown at 1028, if the UE 1002 determines that it is not moving towards a place/destination and/or is not using a set of routes that is in the list of frequently travelled routes/places, the UE 1002 may determine the current destination of the UE 1002 and/or the current planned/estimated route of the UE 1002 (e.g., which may be obtained at 1020) as the priority for purposes of downloading map data packets from the server 1004. For example, map data packet(s) related to current location of the UE 1002 may be given the highest priority, map data packet(s) related to destination of the UE 1002 may be given a next highest priority, and the rest of map data packet(s) may be given a low priority, etc.

Aspects presented herein are directed to enhancements of OTA (over-the-air) map updates to provide more optimal OTA map updates based on the needs of individual vehicles. Map updates are prioritized based on current location and route of the vehicle. The present disclosure includes the following aspects: customizable updates per profile/vehicle; determine and decide the priority dynamically based on current location and current route of the vehicle. System that is running the vehicle will dynamically notify or negotiate with could server to segregate map data updates based on set priorities and update the packets with priority flag; map can be updated in chunks based on priority and vehicle will receive priority data immediately. Detailed Process: 1. Device determines vehicle route path and direction based on GPS location and Route map path. 2. Device periodically checks with the server to see if there are any available updates, in the route path that it is travelling. 3. Assuming HD map data from server is categorized based on priority and segregated over multiple OTA packets. 4. Based on vehicle speed, location and direction, system can determine the priority. 5. Device checks for the high priority flag and downloads the package on priority while other updates are downloaded in the background. 6. The device will verify the integrity of the update package to ensure that it is authentic and has not been tampered with during the download process.

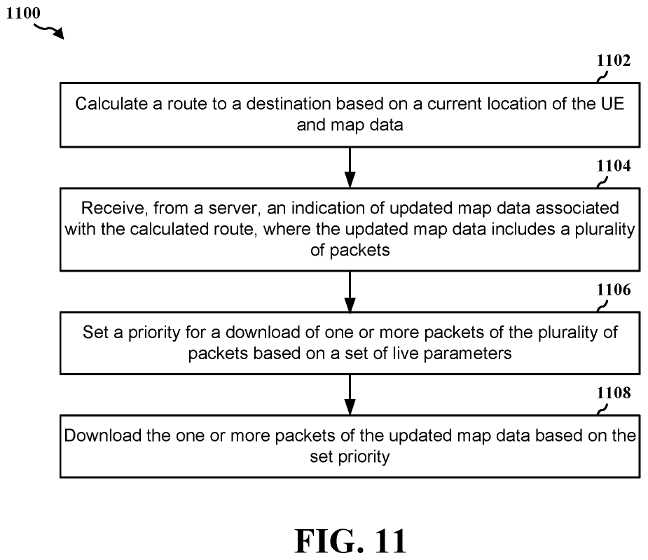

FIG. 11 is a flowchart 1100 of a method of wireless communication. The method may be performed by a UE (e.g., the UE 104, 404, 702, 802, 902, 1002; the vehicle 502; the apparatus 1204). The method may enable the UE to download map data in packets based on a set of priorities to improve the efficiency of updating/retrieving map data.

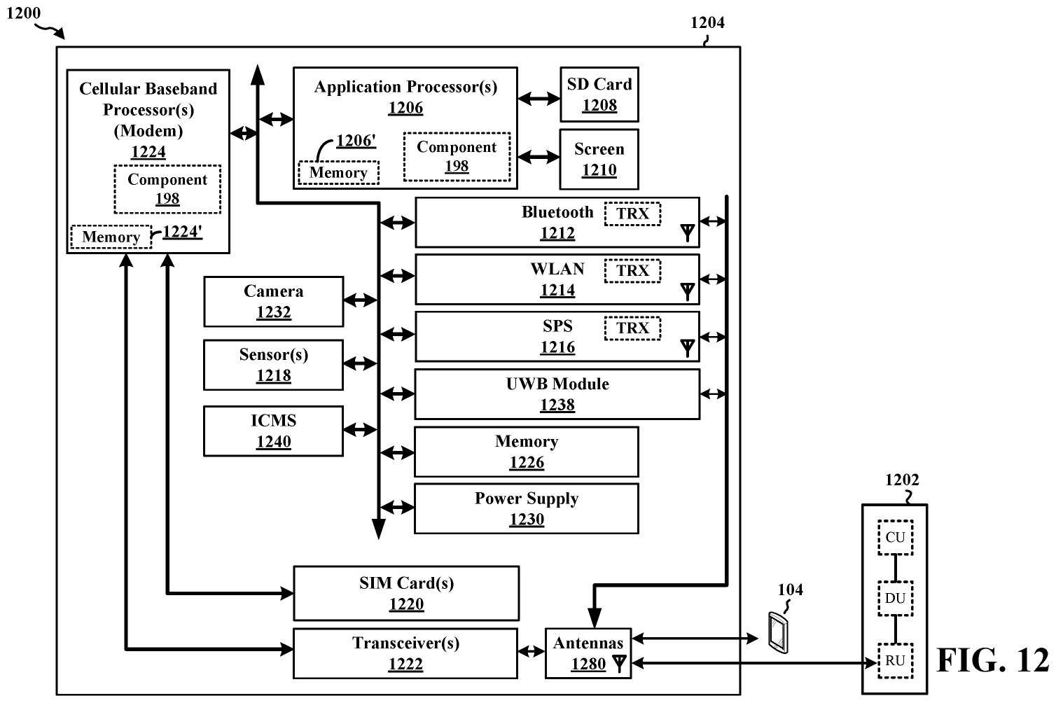

At 1102, the UE may calculate a route to a destination based on a current location of the UE and map data, such as described in connection with FIGS. 8 to 10. For example, as discussed in connection with FIG. 8, the UE 802 may determine its current or estimated location based on GNSS/GPS, or using network-based positioning as described in connection with FIG. 4. The UE 802 may also determine its destination (and also the planned route/path to the destination) based on an input from the user of the UE 802 (e.g., the UE 802 is a navigation device/system or running a navigation application, etc.) and an existing map data in the UE 802. The calculation of the route to the destination may be performed by, e.g., the map data update component 198, the transceiver(s) 1222, the cellular baseband processor(s) 1224, and/or the application processor(s) 1206 of the apparatus 1204 in FIG. 12.

At 1104, the UE may receive, from a server, an indication of updated map data associated with the calculated route, where the updated map data includes a plurality of packets, such as described in connection with FIGS. 8 to 10. For example, as discussed in connection with FIG. 8, based on the information related to the UE 802, the UE 802 may be configured to periodically check with the server 804 to see if there are any available map data updates, such as in the route path that the UE 802 is travelling. If there are map data updates, the server 804 may transmit an indication of the updated map data to the UE 802. The reception of the indication may be performed by, e.g., the map data update component 198, the transceiver(s) 1222, the cellular baseband processor(s) 1224, and/or the application processor(s) 1206 of the apparatus 1204 in FIG. 12.

At 1106, the UE may set a priority for a download of one or more packets of the plurality of packets based on a set of live parameters, such as described in connection with FIGS. 8 to 10. For example, as shown at 820 of FIG. 8, the UE 802 may provide information related to the UE 802 to the server 804 (or the server 804 may detect such information using sensors or received them from another entity). Based on this information, the server 804 may segregate the map data 806 into multiple packets and assign a priority for each packet. In some examples, the server 804 may be configured to segregate the map data 806 into multiple packets first, and then assign the priorities to the packets based on information related to the UE 802. In other examples, the server 804 may be configured to determine the information related to the UE 802 first (e.g., received from the UE 802 or detected using sensors, etc.), and segregate the map data 806 into multiple packets with assigned priorities based on information related to the UE 802. In other examples, the priorities may be set by the UE 802 based on similar or the same priority rules applied at the server 804. The setting of the priority may be performed by, e.g., the map data update component 198, the transceiver(s) 1222, the cellular baseband processor(s) 1224, and/or the application processor(s) 1206 of the apparatus 1204 in FIG. 12.

At 1108, the UE may download the one or more packets of the updated map data based on the set priority, such as described in connection with FIGS. 8 to 10. For example, as shown at 822 of FIG. 8, the server 804 may transmit the packets of the map data 806 (or the UE 802 may download the packets of the map data 806) based on the priorities associated with the packets. For example, the server 804 may transmit (or the UE 802 may download) the second packet 810 first, then the third packet 812, and then the first packet 808, etc. The downloading of the one or more packets of the updated map data may be performed by, e.g., the map data update component 198, the transceiver(s) 1222, the cellular baseband processor(s) 1224, and/or the application processor(s) 1206 of the apparatus 1204 in FIG. 12.

In one example, the UE may update the calculated route based on the downloaded one or more packets, and the UE may output a second indication of the updated calculated route. In some implementations, to output the second indication of the updated calculated route, the UE may store, in a memory or a cache, the second indication of the updated calculated route, or transmit the second indication of the updated calculated route.

In another example, the UE may transmit, to the server, a second indication of the calculated route and the set of live parameters, where to receive the indication of the updated map data, the UE may receive the indication of the updated map data based on the calculated route and the set of live parameters.

In another example, the UE may receive, from the server, a second indication of the map data, where to calculate the route, the UE may calculate the route based on the map data.

In another example, the UE may perform a periodic check with the server to determine whether there is an update for the map data, where to receive the indication of the updated map data, the UE may receive the indication of the updated map data based on the periodic check.

In another example, the set of live parameters includes at least one of: a speed of the UE, a location of the UE, a direction of the UE, or a set of frequently used routes.

In another example, to set the priority for downloading the one or more packets of the updated map data based on the set of live parameters, the UE may assign a first set of packets in the plurality of packets with a first priority, and assign a second set of packets in the plurality of packets with a second priority. In some implementations, to download the one or more packets of the updated map data based on the set priority, the UE may download the first set of packets prior to downloading the second set of packets or download the second set of packets in a background setting. In some implementations, the first set of packets may be associated with a set of frequently-used routes and the second set of packets may be associated with a set of less frequently-used routes compared to the first set of packets.

In another example, the UE may estimate the current location of the UE based on the map data and GPS data.

In another example, the UE may verify the downloaded one or more packets for integrity, and discard the one or more packets or request the server to resend the one or more packets if the one or more packets are verified to be non-authentic or tampered.

In another example, the UE may receive a request to provide a route guidance or an autonomous driving to the destination, where to calculate the route, the UE may calculate the route based on the request.

In another example, the map data and the updated map data may be HD map data.

In another example, the UE may be an autonomous driving vehicle.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an ultrawide band (UWB) module 1238, an in-cabin monitoring system (ICMS) 1240, an SPS module 1216 (e.g., GNSS module), one or more sensors 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the UWB module 1238, the ICMS 1240, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the map data update component 198 may be configured to calculate a route to a destination based on a current location of the UE and map data. The map data update component 198 may also be configured to receive, from a server, an indication of updated map data associated with the calculated route, where the updated map data includes a plurality of packets. The map data update component 198 may also be configured to set a priority for a download of one or more packets of the plurality of packets based on a set of live parameters. The map data update component 198 may also be configured to download the one or more packets of the updated map data based on the set priority. The map data update component 198 may be within the cellular baseband processor(s) 1224, the application processor(s) 1206, or both the cellular baseband processor(s) 1224 and the application processor(s) 1206. The map data update component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for calculating a route to a destination based on a current location of the UE and map data. The apparatus 1204 may further include means for receiving, from a server, an indication of updated map data associated with the calculated route, where the updated map data includes a plurality of packets. The apparatus 1204 may further include means for setting a priority for a download of one or more packets of the plurality of packets based on a set of live parameters. The apparatus 1204 may further include means for downloading the one or more packets of the updated map data based on the set priority.

In one configuration, the apparatus 1204 may further include means for updating the calculated route based on the downloaded one or more packets, and means for outputting a second indication of the updated calculated route. In some implementations, the means for outputting the second indication of the updated calculated route may include configuring the apparatus 1204 to store, in a memory or a cache, the second indication of the updated calculated route, or transmit the second indication of the updated calculated route.

In another configuration, the apparatus 1204 may further include means for transmitting, to the server, a second indication of the calculated route and the set of live parameters, where the means for receiving the indication of the updated map data may include configuring the apparatus 1204 to receive the indication of the updated map data based on the calculated route and the set of live parameters.

In another configuration, the apparatus 1204 may further include means for receiving, from the server, a second indication of the map data, where the means for calculating the route may include configuring the apparatus 1204 to calculate the route based on the map data.

In another configuration, the apparatus 1204 may further include means for performing a periodic check with the server to determine whether there is an update for the map data, where the means for receiving the indication of the updated map data may include configuring the apparatus 1204 to receive the indication of the updated map data based on the periodic check.

In another configuration, the set of live parameters includes at least one of: a speed of the UE, a location of the UE, a direction of the UE, or a set of frequently used routes.

In another configuration, the means for setting the priority for downloading the one or more packets of the updated map data based on the set of live parameters may include configuring the apparatus 1204 to assign a first set of packets in the plurality of packets with a first priority, and assign a second set of packets in the plurality of packets with a second priority. In some implementations, the means for downloading the one or more packets of the updated map data based on the set priority may include configuring the apparatus 1204 to download the first set of packets prior to downloading the second set of packets or download the second set of packets in a background setting. In some implementations, the first set of packets may be associated with a set of frequently-used routes and the second set of packets may be associated with a set of less frequently-used routes compared to the first set of packets.

In another configuration, the apparatus 1204 may further include means for estimating the current location of the UE based on the map data and GPS data.

In another configuration, the apparatus 1204 may further include means for verifying the downloaded one or more packets for integrity, and means for discarding the one or more packets or means for requesting the server to resend the one or more packets if the one or more packets are verified to be non-authentic or tampered.

In another configuration, the apparatus 1204 may further include means for receiving a request to provide a route guidance or an autonomous driving to the destination, where the means for calculating the route may include configuring the apparatus 1204 to calculate the route based on the request.

In another configuration, the map data and the updated map data may be HD map data.

In another configuration, the apparatus 1204 may be an autonomous driving vehicle.

The means may be the map data update component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

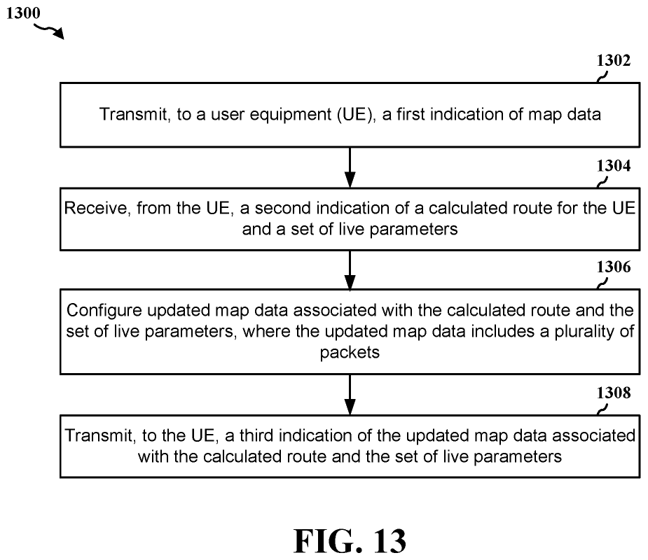

FIG. 13 is a flowchart 1300 of a method of wireless communication. The method may be performed by a network entity (e.g., the server 704, 804, 904, 1004; the network entity 1460). The method may enable the server to segregate map data into packets and transmit the packets to a UE based on a set of priorities, where the set of priorities may be associated with the movement of the UE.

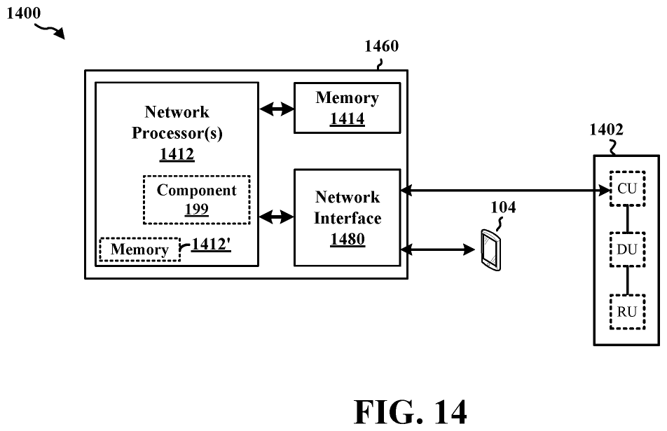

At 1302, the network entity may calculate a route to a destination based on a current location of the UE and map data, such as described in connection with FIGS. 8 to 10. For example, as discussed in connection with FIG. 8, the server 804 may determine the current location/estimated location of the UE 802, the destination of the UE 802, and/or the route of the UE 802 based on information provided by the UE 802 and the map data associated with area expected to be travelled by the UE 802. The calculation of the route to the destination may be performed by, e.g., the map data segregation component 199, the network processor(s) 1412, and/or the network interface 1480 of the network entity 1460 in FIG. 14.

At 1304, the network entity may receive, from the UE, a second indication of a calculated route for the UE and a set of live parameters, such as described in connection with FIGS. 8 to 10. For example, as discussed in connection with FIG. 8, instead of downloading the whole map data 806 at the same time (or at once), a server 804 (e.g., a map server, a cloud server, etc.) may be configured to categorize/segregate the map data 806 based on at least one input from a UE 802. In one example, the at least one input may include information related to the UE 802, such as the location of the UE 802, the destination of the UE 802, the speed of the UE 802, the direction of the UE 802, frequency route(s) used by the UE 802, and/or the planned/current route path (e.g., computed by a navigation application) of the UE 802, etc. In some examples, this information may also be referred to a set of live parameters. The reception of the second indication may be performed by, e.g., the map data segregation component 199, the network processor(s) 1412, and/or the network interface 1480 of the network entity 1460 in FIG. 14.

At 1306, the network entity may configure updated map data associated with the calculated route and the set of live parameters, where the updated map data includes a plurality of packets, such as described in connection with FIGS. 8 to 10. For example, as discussed in connection with 820 of FIG. 8, the UE 802 may provide information related to the UE 802 to the server 804 (or the server 804 may detect such information using sensors or received them from another entity). Based on this information, the server 804 may segregate the map data 806 into multiple packets (which may also be referred to as OTA packets or map data packets) and assign a priority for each packet. The configuration of the updated map data may be performed by, e.g., the map data segregation component 199, the network processor(s) 1412, and/or the network interface 1480 of the network entity 1460 in FIG. 14.

At 1308, the network entity may transmit, to the UE, a third indication of the updated map data associated with the calculated route and the set of live parameters, such as described in connection with FIGS. 8 to 10. For example, if there are map data updates, the server 804 may transmit an indication of the updated map data to the UE 802. Then, as shown at 824, the server 804 may transmit the packets of the map data 806 (or the UE 802 may download the packets of the map data 806) based on the priorities associated with the packets. The transmission of the third indication may be performed by, e.g., the map data segregation component 199, the network processor(s) 1412, and/or the network interface 1480 of the network entity 1460 in FIG. 14.

In one example, the network entity may transmit one or more packets in the plurality of packets based on a priority associated with the calculated route and the set of live parameters.

In another example, the network entity may receive, from the UE, a periodic inquiry for whether there is an update for the map data, where to transmit the third indication of the updated map data, the network entity may transmit the third indication of the updated map data based on the periodic inquiry.

In another example, the set of live parameters includes at least one of: a speed of the UE, a location of the UE, a direction of the UE, or a set of frequently used routes.

In another example, the network entity may transmit, to the UE, one or more packets of the plurality of packets, and receive, from the UE, a request to resend the one or more packets if the one or more packets are verified to be non-authentic or tampered.

In another example, the map data and the updated map data may be HD map data.

In another example, the UE may be an autonomous driving vehicle.

FIG. 14 is a diagram 1400 illustrating an example of a hardware implementation for a network entity 1460. In one example, the network entity 1460 may be within the core network 120. The network entity 1460 may include at least one network processor 1412. The network processor(s) 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The network processor(s) 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the map data segregation component 199 may be configured to transmit, to a UE, a first indication of map data. The map data segregation component 199 may also be configured to receive, from the UE, a second indication of a calculated route for the UE and a set of live parameters. The map data segregation component 199 may also be configured to configure updated map data associated with the calculated route and the set of live parameters, where the updated map data includes a plurality of packets. The map data segregation component 199 may also be configured to transmit, to the UE, a third indication of the updated map data associated with the calculated route and the set of live parameters. The map data segregation component 199 may be within the network processor(s) 1412. The map data segregation component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1460 may include a variety of components configured for various functions. In one configuration, the network entity 1460 may include means for transmitting, to a UE, a first indication of map data. The network entity 1460 may further include means for receiving, from the UE, a second indication of a calculated route for the UE and a set of live parameters. The network entity 1460 may further include means for configuring updated map data associated with the calculated route and the set of live parameters, where the updated map data includes a plurality of packets. The network entity 1460 may further include means for transmitting, to the UE, a third indication of the updated map data associated with the calculated route and the set of live parameters.

In one configuration, the network entity 1460 may further include means for transmitting one or more packets in the plurality of packets based on a priority associated with the calculated route and the set of live parameters.

In another configuration, the network entity 1460 may further include means for receiving, from the UE, a periodic inquiry for whether there is an update for the map data, where the means for transmitting the third indication of the updated map data may include configuring the network entity 1460 to may transmit the third indication of the updated map data based on the periodic inquiry.

In another configuration, the set of live parameters includes at least one of: a speed of the UE, a location of the UE, a direction of the UE, or a set of frequently used routes.

In another configuration, the network entity 1460 may further include means for transmitting, to the UE, one or more packets of the plurality of packets, and means for receiving, from the UE, a request to resend the one or more packets if the one or more packets are verified to be non-authentic or tampered.

In another configuration, the map data and the updated map data may be HD map data.

In another configuration, the UE may be an autonomous driving vehicle.

The means may be the map data segregation component 199 of the network entity 1460 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: calculating a route to a destination based on a current location of the UE and map data; receiving, from a server, an indication of updated map data associated with the calculated route, wherein the updated map data includes a plurality of packets; setting a priority for a download of one or more packets of the plurality of packets based on a set of live parameters; and downloading the one or more packets of the updated map data based on the set priority.

Aspect 2 is the method of aspect 1, further comprising: updating the calculated route based on the downloaded one or more packets; and outputting a second indication of the updated calculated route.

Aspect 3 is the method of aspect 1 or aspect 2, wherein outputting the second indication of the updated calculated route comprises: storing, in a memory or a cache, the second indication of the updated calculated route; or transmitting the second indication of the updated calculated route.

Aspect 4 is the method of any of aspects 1 to 3, further comprising: transmitting, to the server, a second indication of the calculated route and the set of live parameters, wherein receiving the indication of the updated map data comprises receiving the indication of the updated map data based on the calculated route and the set of live parameters.

Aspect 5 is the method of any of aspects 1 to 4, further comprising: receiving, from the server, a second indication of the map data, wherein calculating the route comprises calculating the route based on the map data.

Aspect 6 is the method of any of aspects 1 to 5, further comprising: performing a periodic check with the server to determine whether there is an update for the map data, wherein receiving the indication of the updated map data comprises receiving the indication of the updated map data based on the periodic check.

Aspect 7 is the method of any of aspects 1 to 6, wherein the set of live parameters includes at least one of: a speed of the UE, a location of the UE, a direction of the UE, or a set of frequently used routes.

Aspect 8 is the method of any of aspects 1 to 7, wherein setting the priority for downloading the one or more packets of the updated map data based on the set of live parameters comprises: assigning a first set of packets in the plurality of packets with a first priority; and assigning a second set of packets in the plurality of packets with a second priority.

Aspect 9 is the method of any of aspects 1 to 8, wherein downloading the one or more packets of the updated map data based on the set priority comprises: downloading the first set of packets prior to downloading the second set of packets or downloading the second set of packets in a background setting.

Aspect 10 is the method of any of aspects 1 to 9, wherein the first set of packets is associated with a set of frequently-used routes and the second set of packets is associated with a set of less frequently-used routes compared to the first set of packets.

Aspect 11 is the method of any of aspects 1 to 10, further comprising: estimating the current location of the UE based on the map data and Global Positioning System (GPS) data.

Aspect 12 is the method of any of aspects 1 to 11, further comprising: verifying the downloaded one or more packets for integrity; and discarding the one or more packets or requesting the server to resend the one or more packets if the one or more packets are verified to be non-authentic or tampered.

Aspect 13 is the method of any of aspects 1 to 12, further comprising: receiving a request to provide a route guidance or an autonomous driving to the destination, wherein calculating the route comprises calculating the route based on the request.

Aspect 14 is the method of any of aspects 1 to 13, wherein the map data and the updated map data are high-definition (HD) map data.

Aspect 15 is the method of any of aspects 1 to 14, wherein the UE is an autonomous driving vehicle.

Aspect 16 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 15.

Aspect 17 is the apparatus of aspect 16, further including at least one of a transceiver or an antenna coupled to the at least one processor.

Aspect 18 is an apparatus for wireless communication including means for implementing any of aspects 1 to 15.

Aspect 19 is a computer-readable medium (e.g., a non-transitory computer-readable medium) storing computer executable code, where the code when executed by a processor causes the processor to implement any of aspects 1 to 15.

Aspect 20 is a method of wireless communication at a server, comprising: transmitting, to a user equipment (UE), a first indication of map data; receiving, from the UE, a second indication of a calculated route for the UE and a set of live parameters; configuring updated map data associated with the calculated route and the set of live parameters, wherein the updated map data includes a plurality of packets; and transmitting, to the UE, a third indication of the updated map data associated with the calculated route and the set of live parameters.

Aspect 21 is the method of aspect 20, further comprising: transmitting one or more packets in the plurality of packets based on a priority associated with the calculated route and the set of live parameters.

Aspect 22 is the method of aspect 20 or aspect 21, further comprising: receiving, from the UE, a periodic inquiry for whether there is an update for the map data, wherein transmitting the third indication of the updated map data comprises transmitting the third indication of the updated map data based on the periodic inquiry.

Aspect 23 is the method of any of aspects 20 to 22, wherein the set of live parameters includes at least one of: a speed of the UE, a location of the UE, a direction of the UE, or a set of frequently used routes.

Aspect 24 is the method of any of aspects 20 to 23, further comprising: transmitting, to the UE, one or more packets of the plurality of packets; and receiving, from the UE, a request to resend the one or more packets if the one or more packets are verified to be non-authentic or tampered.

Aspect 25 is the method of any of aspects 20 to 24, wherein the map data and the updated map data are high-definition (HD) map data.

Aspect 26 is the method of any of aspects 20 to 25, wherein the UE is an autonomous driving vehicle.

Aspect 27 is an apparatus for wireless communication at a server, including: at least one memory; and at least one processor coupled to the at least one memory and, based at least in part on information stored in the at least one memory, the at least one processor, individually or in any combination, is configured to implement any of aspects 20 to 26.

Aspect 28 is the apparatus of aspect 27, further including at least one of a transceiver or an antenna coupled to the at least one processor.

Aspect 29 is an apparatus for wireless communication including means for implementing any of aspects 20 to 26.

Aspect 30 is a computer-readable medium (e.g., a non-transitory computer-readable medium) storing computer executable code, where the code when executed by a processor causes the processor to implement any of aspects 20 to 26.

What is claimed is:

1. An apparatus for wireless communication at a user equipment (UE), comprising:
at least one memory; and
at least one processor coupled to the at least one memory, the at least one processor, individually or in any combination, is configured to:
calculate a route to a destination based on a current location of the UE and map data;
receive, from a server, an indication of updated map data associated with the calculated route, wherein the updated map data includes a plurality of packets;
set a priority for a download of one or more packets of the plurality of packets based on a set of live parameters; and
download the one or more packets of the updated map data based on the set priority.

2. The apparatus of claim 1, wherein the at least one processor, individually or in any combination, is further configured to:
update the calculated route based on the downloaded one or more packets; and
output a second indication of the updated calculated route.

3. The apparatus of claim 2, wherein to output the second indication of the updated calculated route, the at least one processor, individually or in any combination, is configured to:
store, in a memory or a cache, the second indication of the updated calculated route; or
transmit the second indication of the updated calculated route.

4. The apparatus of claim 1, wherein the at least one processor, individually or in any combination, is further configured to:
transmit, to the server, a second indication of the calculated route and the set of live parameters, wherein to receive the indication of the updated map data, the at least one processor, individually or in any combination, is configured to receive the indication of the updated map data based on the calculated route and the set of live parameters.

5. The apparatus of claim 1, wherein the at least one processor, individually or in any combination, is further configured to:
receive, from the server, a second indication of the map data, wherein to calculate the route, the at least one processor, individually or in any combination, is configured to calculate the route based on the map data.

6. The apparatus of claim 1, wherein the at least one processor, individually or in any combination, is further configured to:
perform a periodic check with the server to determine whether there is an update for the map data, wherein to receive the indication of the updated map data, the at least one processor, individually or in any combination, is configured to receive the indication of the updated map data based on the periodic check.

7. The apparatus of claim 1, wherein the set of live parameters includes at least one of:
a speed of the UE,
a location of the UE,
a direction of the UE, or
a set of frequently used routes.

8. The apparatus of claim 1, wherein to set the priority for downloading the one or more packets of the updated map data based on the set of live parameters, the at least one processor, individually or in any combination, is configured to:
assign a first set of packets in the plurality of packets with a first priority; and
assign a second set of packets in the plurality of packets with a second priority.

9. The apparatus of claim 8, wherein to download the one or more packets of the updated map data based on the set priority, the at least one processor, individually or in any combination, is configured to:
download the first set of packets prior to downloading the second set of packets or download the second set of packets in a background setting.

10. The apparatus of claim 8, wherein the first set of packets is associated with a set of frequently-used routes and the second set of packets is associated with a set of less frequently-used routes compared to the first set of packets.

11. The apparatus of claim 1, wherein the at least one processor, individually or in any combination, is further configured to:
estimate the current location of the UE based on the map data and Global Positioning System (GPS) data.

12. The apparatus of claim 1, wherein the at least one processor, individually or in any combination, is further configured to:
verify the downloaded one or more packets for integrity; and
discard the one or more packets or request the server to resend the one or more packets if the one or more packets are verified to be non-authentic or tampered.

13. The apparatus of claim 1, wherein the at least one processor, individually or in any combination, is further configured to:
receive a request to provide a route guidance or an autonomous driving to the destination, wherein to calculate the route, the at least one processor, individually or in any combination, is configured to calculate the route based on the request.

14. The apparatus of claim 1, wherein the map data and the updated map data are high-definition (HD) map data.

15. The apparatus of claim 1, wherein the UE is an autonomous driving vehicle.

16. A method of wireless communication at a user equipment (UE), comprising:
calculating a route to a destination based on a current location of the UE and map data;
receiving, from a server, an indication of updated map data associated with the calculated route, wherein the updated map data includes a plurality of packets;
setting a priority for a download of one or more packets of the plurality of packets based on a set of live parameters; and
downloading the one or more packets of the updated map data based on the set priority.

17. The method of claim 16, further comprising:
updating the calculated route based on the downloaded one or more packets; and
outputting a second indication of the updated calculated route.

18. The method of claim 16, further comprising:
transmitting, to the server, a second indication of the calculated route and the set of live parameters, wherein receiving the indication of the updated map data comprises receiving the indication of the updated map data based on the calculated route and the set of live parameters.

19. The method of claim 16, wherein setting the priority for downloading the one or more packets of the updated map data based on the set of live parameters comprises:
assigning a first set of packets in the plurality of packets with a first priority; and
assigning a second set of packets in the plurality of packets with a second priority.

20. The method of claim 16, further comprising:
verifying the downloaded one or more packets for integrity; and
discarding the one or more packets or requesting the server to resend the one or more packets if the one or more packets are verified to be non-authentic or tampered.

21. An apparatus for wireless communication at a server, comprising:
at least one memory; and
at least one processor coupled to the at least one memory, the at least one processor, individually or in any combination, is configured to:
transmit, to a user equipment (UE), a first indication of map data;
receive, from the UE, a second indication of a calculated route for the UE and a set of live parameters;
configure updated map data associated with the calculated route and the set of live parameters, wherein the updated map data includes a plurality of packets; and
transmit, to the UE, a third indication of the updated map data associated with the calculated route and the set of live parameters.

22. The apparatus of claim 21, wherein the at least one processor, individually or in any combination, is further configured to:
transmit one or more packets in the plurality of packets based on a priority associated with the calculated route and the set of live parameters.

23. The apparatus of claim 21, wherein the at least one processor, individually or in any combination, is further configured to:
receive, from the UE, a periodic inquiry for whether there is an update for the map data, wherein to transmit the third indication of the updated map data, the at least one processor, individually or in any combination, is configured to transmit the third indication of the updated map data based on the periodic inquiry.

24. The apparatus of claim 21, wherein the set of live parameters includes at least one of:
a speed of the UE,
a location of the UE,
a direction of the UE, or
a set of frequently used routes.

25. The apparatus of claim 21, wherein the at least one processor, individually or in any combination, is further configured to:
transmit, to the UE, one or more packets of the plurality of packets; and
receive, from the UE, a request to resend the one or more packets if the one or more packets are verified to be non-authentic or tampered.

26. The apparatus of claim 21, wherein the map data and the updated map data are high-definition (HD) map data.

27. The apparatus of claim 21, wherein the UE is an autonomous driving vehicle.

28. A method of wireless communication at a server, comprising:
transmitting, to a user equipment (UE), a first indication of map data;
receiving, from the UE, a second indication of a calculated route for the UE and a set of live parameters;
configuring updated map data associated with the calculated route and the set of live parameters, wherein the updated map data includes a plurality of packets; and
transmitting, to the UE, a third indication of the updated map data associated with the calculated route and the set of live parameters.

29. The method of claim 28, further comprising:
transmitting one or more packets in the plurality of packets based on a priority associated with the calculated route and the set of live parameters.

30. The method of claim 28, further comprising:
transmitting, to the UE, one or more packets of the plurality of packets; and
receiving, from the UE, a request to resend the one or more packets if the one or more packets are verified to be non-authentic or tampered.
